(19) United States
(12) Patent Application Publication
(10) Pub. No.: US 2023/0267271 A1
(43) Pub. Date: Aug. 24, 2023

(54) AUTO CONVERSION SYSTEM AND METHOD OF MANUSCRIPT FORMAT

(71) Applicant: RESEARCH FACTORY AND PUBLICATION INC., Bucheon-si (KR)

(72) Inventor: Jeoungju RYU, Bucheon-si (KR)

(21) Appl. No.: 17/971,115

(22) Filed: Oct. 21, 2022

(30) Foreign Application Priority Data
Feb. 24, 2022 (KR) 10-2022-0024123

(51) Int. Cl. G06F 40/186; G06F 40/103; G06F 40/40

(52) U.S. Cl. CPC G06F 40/186; G06F 40/103; G06F 40/40

(57) ABSTRACT

An automatic paper format conversion system is disclosed. An automatic paper format conversion system may include an editor which defines a template file based on edition of a document structure and edition of a document rule, and a converter which receives a source file and the template file as inputs and converts a source file structure so as to correspond to the template file to generate a result file.

### BACKGROUND

### Field

The present disclosure relates to an automatic paper format conversion system and a method thereof, and more particularly, to a program which defines a template according to each of formats required by various journals and converts content of an original paper (source file) so as to correspond to the defined template.

### Description of the Related Art

When submitting a medical journal, an author should revise and submit the paper according to a format required by the journal to which the paper is to be submitted. Currently, there are more than 7,000 medical journals based on science citation index expanded (SCIE), but formats required by the journals are different from each other. Therefore, in a situation where a paper is submitted to several journals for paper approval, the author has inconvenience of having to revise the paper with the same content in a different format, which may cause a drawback, such as delay in research progress.

Currently, programs such as Zotero and EndNote are utilized as programs for managing bibliographic data of the research materials, but the program cannot convert the format of the entire paper.

A related art of the present disclosure is disclosed in Korean Registered Patent Publication No. 10-1243057.

### SUMMARY

In order to solve the problems of the related art, an object of the present disclosure is to provide an automatic paper format conversion system and a method thereof which define a template file by editing a document structure and a document rule to structurize a format different for each journal.

In order to solve the drawbacks of the related art, an object of the present disclosure is to provide an automatic paper format conversion system and a method thereof which figure out a structure and a format of a source file based on natural language processing and convert content of a document of the source file according to a defined format of the template file.

However, objects to be achieved by various embodiments of the present disclosure are not limited to the technical objects as described above and other technical objects may be present.

As a technical means to achieve the above-described technical object, according to an aspect of the present disclosure, an automatic paper format conversion system may include an editor which defines a template file based on edition of a document structure and edition of a document rule; and a converter which receives a source file and the template file as inputs and converts a source file structure so as to correspond to the template file to generate a result file.

According to an exemplary embodiment of the present disclosure, the converter may figure out the source file structure based on natural language processing and identify an input item based on the source file structure.

According to an exemplary embodiment of the present disclosure, the converter may automatically convert a format of the input item so as to correspond to the document structure and the document rule.

According to an exemplary embodiment of the present disclosure, the editor may include a structure tree and define the document structure based on the edition of the property of each node of the structure tree.

According to an exemplary embodiment of the present disclosure, the node may include a section node, a group node, and an item node, the section node may be a node for dividing a layout including a title section and a main section, the group node be a node obtained by grouping a plurality of item nodes, and the item node be a node corresponding to an item output to the result file.

According to an exemplary embodiment of the present disclosure, the editor may define the document rule to limit the number of at least one of characters, tables, and figures of a specific item.

As a technical means to achieve the above-described technical object, according to another aspect of the present disclosure, an automatic paper format conversion method may include defining a template file based on edition of a document structure and edition of a document rule; and generating a result file by receiving a source file and the template file as inputs and converting a source file structure so as to correspond to the template file.

According to an exemplary embodiment of the present disclosure, in the generating of a result file, the source file structure may be figured out based on natural language processing and an input item be identified based on the source file structure.

According to an exemplary embodiment of the present disclosure, in the generating of a result file, the format of the input item may be automatically converted so as to correspond to the document structure and the document rule.

According to an exemplary embodiment of the present disclosure, the document structure may be defined based on property edition of each node of the structure tree which defines the template file.

According to an exemplary embodiment of the present disclosure, the node may include a section node, a group node, and an item node, the section node be a node for dividing a layout including a title section and a main section, the group node be a node obtained by grouping a plurality of item nodes, and the item node be a node corresponding to an item output to the result file.

According to an exemplary embodiment of the present disclosure, in the defining of the template file, the document rule may be defined to limit the number of at least one of characters, tables, and figures of a specific item.

The above-described solving means are merely illustrative but should not be construed as limiting the present disclosure. In addition to the above-described embodiments, additional embodiments may be further provided in the drawings and the detailed description of the present disclosure.

According to the above-described solving means of the present disclosure, the template file may be defined by editing the document structure and the document rule to structurize a format different for every journal.

According to the above-described solving means of the present disclosure, the structure and the format of the source file may be figured out based on the natural language processing and the content of the document of the source file be converted according to the format of the template file to simply and quickly convert the source file into a different journal format.

However, the effect which can be achieved by the present disclosure may be not limited to the above-described effects, there may be other effects.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram of an automatic paper format conversion system according to an exemplary embodiment of the present disclosure;

FIG. 2 is an overall execution screen of an editor according to an exemplary embodiment of the present disclosure;

FIG. 3 is an execution screen of an editor according to an exemplary embodiment of the present disclosure for generating a separate document;

FIG. 4 is an execution screen of an editor according to an exemplary embodiment of the present disclosure for defining a document rule related to comment insertion;

FIG. 5 is an execution screen of an editor according to an exemplary embodiment of the present disclosure for defining a document rule related to limitation of the number;

FIG. 6 is an execution screen of an editor according to an exemplary embodiment of the present disclosure for editing a property of a section node;

FIG. 7 is an execution screen of an editor according to an exemplary embodiment of the present disclosure for editing a property of a group node;

FIG. 8 is an execution screen of an editor according to an exemplary embodiment of the present disclosure for editing a property of an item node;

FIG. 9 is an execution screen of a converter according to an exemplary embodiment of the present disclosure; and

FIG. 10 is a flowchart of an operation of an automatic paper format conversion method according to an exemplary embodiment of the present disclosure.

### DETAILED DESCRIPTION OF THE EMBODIMENT

Hereinafter, the present disclosure will be described more fully with reference to the accompanying drawings, in which exemplary embodiments of the present disclosure are shown so as to easily embody by a person with ordinary knowledge in the technical field the present disclosure pertains to. However, the present disclosure can be realized in various different forms, and is not limited to the embodiments described herein. Accordingly, in order to clearly explain the present disclosure in the drawings, portions not related to the description are omitted. Like reference numerals designate like elements throughout the specification.

Through the specification of the present disclosure, when it is described that an element is “coupled” to another element, the element may be “directly coupled” to the other element, or “electrically coupled” or “indirectly coupled” to the other element through a third element therebetween.

Through the specification of the present disclosure, when one member is located “on”, “above”, “on an upper portion”, “below”, “under”, and “on a lower portion” of the other member, the member may be adjacent to the other member or a third member may be disposed between the two members.

In the specification of the present disclosure, the word “comprise” will be understood to imply further inclusion of other element but not the exclusion of any other element, unless explicitly described to the contrary.

The present disclosure relates to a system and a method for automatically converting a paper format, and more particularly, to a program which defines a template according to each of formats required by various journals and converts content of an original paper (source file) so as to correspond to the defined template.

Hereinafter, for the convenience of description, the automatic paper format conversion system 100 according to an exemplary embodiment of the present disclosure will be referred to as a conversion system 100.

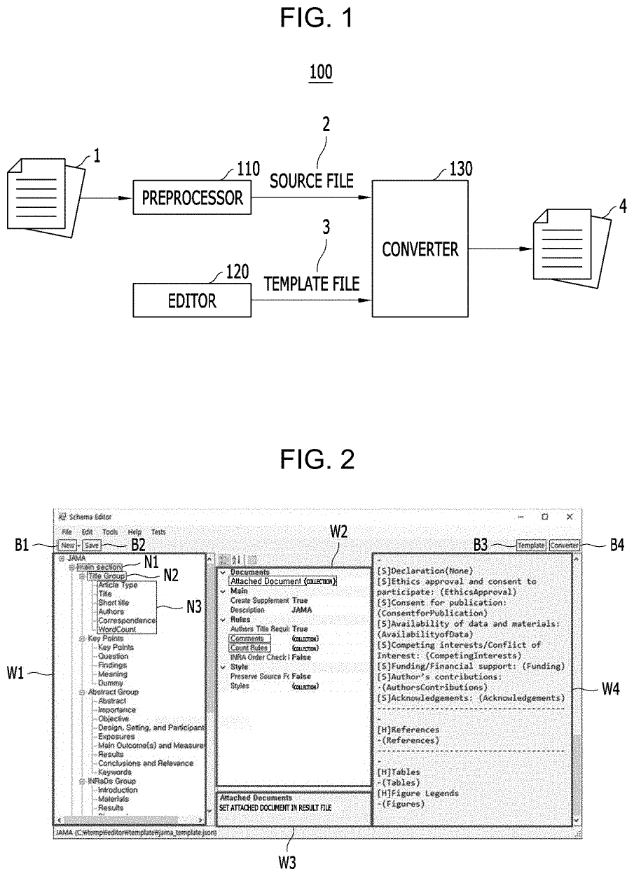

FIG. 1 is a schematic diagram of an automatic paper format conversion system according to an exemplary embodiment of the present disclosure.

Referring to FIG. 1, the conversion system 100 may include a preprocessor 110, an editor 120, and a converter 130.

According to an exemplary embodiment of the present disclosure, the data processing (insertion of a delimiter, figuring-out of a document structure, and identification of input items to be described below) in the preprocessor 110 and the converter 130 is performed based on natural language processing so that even though the term of “natural language processing” is not disclosed below, the preprocessor 110 and the converter 130 of the conversion system 100 may be interpreted as partially borrowing the concept of the existing natural language processing technology.

According to the exemplary embodiment of the present disclosure, the preprocessor 110 may generate a source file 2 in which each item is marked by inserting a delimiter into data in the original file 1. At this time, the generated source file 2 may be stored in the form of \executable\docs\source\sourcenew.docx, but is not limited thereto.

Here, the original file 1 may refer to a file whose paper format is to be converted, that is, a file to be converted and may refer to an input file of the conversion system 100 according to the exemplary embodiment of the present disclosure. Further, a main conversion target of the conversion system 100 disclosed in the present disclosure is a medical paper, but is not limited thereto and various papers or various documents created in a similar format may be conversion targets, as well as the medical paper.

Specifically, the preprocessor 110 may divide the data of the original file 1 by inserting a delimiter into the data with respect to a data breakpoint or a data format such as a paragraph of data and a format style in the original file 1. The delimiter may include # or $, for example.

For example, the preprocessor 110 may divide major classification using “###” as a first level delimiter. For example, the format may be divided such as “###introduction ###” or “###device design ###”. In other words, the preprocessor 110 may insert delimiters on both sides of the data with the data to be divided therebetween. In the same way, the preprocessor 110 may divide minor classification using “##” as a second level delimiter and for example, as the minor classification of “###device design ###” which is the above-described example, the data may be divided as “##design method ##” or “##performance verification ##”.

Further, for example, the preprocessor 110 may use “$$$” as an exclusion delimiter to classify data which is not used to convert the original file 1 as exclusion data so as not to be recognized as an input item by the converter 130 to be described below, but it is not limited thereto. Therefore, the preprocessor 110 according to the exemplary embodiment of the present disclosure may mark and classify each item in the original file 1 using various delimiters other than the above-described delimiters.

Further, a file which is completely marked by classifying the data, by the preprocessor 110, may be output as a source file 2 and then the converter 130 may figure out the source file structure using the delimiter of the source file 2 and identify the input item. The converter 130 will be described in more detail below.

According to the exemplary embodiment of the present disclosure, the editor 120 may define a template file based on the edition of the document structure and the edition of the document rule.

To be more specific, for example, among journals included in the gastroenterology and hepatology section of the science citation index expanded (SCIE), in the case of a gastroenterology journal, there is no character limit for the title and a short title (in which author name, abstract title, a printing date/place, and publisher name are described) is essential, the number of characters of the subtitle is limited to 45 characters including spaces, and the word count of the body is limited to 7,000 words including a main text and a legend of the tables/figures. In the case of the hepatology journal, the title is limited to 120 characters excluding spaces, the short title is not essential. Further, the number of characters of the subtitle is not limited, and the word count of the body is limited to 6,000 words including the description of the references. In the case of the clinical gastroenterology and hepatology journal, the title is limited to 130 characters including the spaces, the short title is essential, the number of characters of the subtitle is limited to 45 characters including the spaces, and the word count of the body is limited to 4,000 words including the description of the references and the legend of the tables/figures.

As described above, each journal requires different document structure such as a configuration which needs to be essentially included or a configuration which is not essentially included, and document rules such as the number of characters or the word count of each item. According to the exemplary embodiment of the present disclosure, the editor 120 may define a template and generate a template file 3 according to the document structure and the document rule of a journal to which the paper is to be submitted, among journals which require the different formats.

According to the exemplary embodiment of the present disclosure, the converter 130 may receive a source file 2 generated in the preprocessor 110 and a template file 3 generated in the editor 120 as inputs, and convert a source file structure so as to correspond to the template file 3 to generate a result file 4.

Specifically, the converter 130 may recognize an item indicated by content between the delimiters, using the delimiter inserted in the preprocessor 110, and analyze and figure out the meaning of the recognized content based on the natural language processing.

For example, the converter 130 may recognize and classify the “introduction” of “###introduction ###” with the delimiter “###” inserted therein, in the source file 2 received from the preprocessor 110, as a main classification item and figure out the meaning of the “introduction” based on the natural language processing. Next, when the second level delimiter “##” is not recognized next to the “###introduction ###” in the source file 2, the converter 130 may recognize the content before recognizing the “###introduction ###” and “###” which is the next first level delimiter, as content corresponding to the major classification “introduction”. Further, when the exclusion delimiter “$$$” is recognized in the source file 2, the converter 130 may recognize the content until next “$$$” is recognized, as exclusion data. The converter 130 may figure out the structure of the source file 2 by means of the process as described above in the example. In other words, the converter 130 may figure out the source file structure based on the natural language processing using the delimiter in the source file 2.

According to the exemplary embodiment of the present disclosure, the converter 130 may identify the input item based on the figured-out source file structure. The input item may refer to an item included in the template file 3, that is, an item according to a format of the journal to be converted, among items (classified major classification, or minor classification) in the source file 2. For example, when the converter 130 figures out that the structure of the source file 2 is configured by title, subtitle, author name, abstract, introduction, body, conclusion, and reference, if the document structure defined in the template file 3 received as an input is formed only by title, author name, abstract, introduction, body, and conclusion, the converter 130 may identify only the title, author name, abstract, introduction, body, and conclusion items, other than the data of the subtitle and the reference which are not required for the template file 3, as the input items, but are not limited thereto.

Further, the converter 130 may automatically convert the input item so as to correspond to the document structure and the document rule defined in the template file 3. For example, as described above in the example, when the structure of the source file 2 is sequentially formed by title, subtitle, author name, abstract, introduction, body, conclusion, and reference and the used word count is 7,000 words, if the document structure defined by the template file 3 is sequentially formed by title, author name, introduction, body, conclusion, and abstract and the word count is limited to 6,000 words according to the document rule, the converter 130 may extract data about title, author name, abstract, introduction, body, and conclusion which are input items corresponding to the document structure defined in the template file 3, rearrange the order to be title, author name, introduction, body, conclusion, and abstract according to the document structure. However, in this case, in order to reduce the word count to 6,000 words, the converter 130 may automatically perform the task of deleting a redundant sentence or unifying the words having the repeated meaning based on the natural language processing. However, it is not limited thereto.

Further, according to another exemplary embodiment of the present disclosure, the converter 130 may include the preprocessor 110. According to the above-described example, the converter 130 may receive the source file 2 from the preprocessor 110, but according to another example, the converter 130 may include the preprocessor 110 to directly receive the original file 1.

Specifically, the converter 130 may receive the original file 1, insert the delimiter, and figure out each item and the meaning of the data based on the natural language processing. However, in this case, according to the document structure and the document rule defined in the template file 3 received from the editor 120, the converter may insert the exclusion delimiter to exclude an item which is not required for the template file 3 and data corresponding to this item and identify the item which is not excluded as an input item. In other words, the converter 130 may receive the template file 3 generated from the editor 120 and insert the delimiter in consideration of the document structure and the document rule defined in the template file 3.

For example, when the converter 130 inserts the delimiter into the data in the original file 1 and the item divided by the delimiter includes title, subtitle, author name, abstract, introduction, body, conclusion, and reference, if the document structure defined in the template file 3 received as an input includes only title, author name, abstract, introduction, body, and conclusion, the exclusion delimiter may be inserted into the items which are not included in the document structure, that is, subtitle and reference to be excluded from the input item. However, it is not limited thereto and it is interpreted as one of various exemplary embodiments of the present disclosure.

As described above, the conversion system 100 according to the exemplary embodiment of the present disclosure may figure out the structure and the format of the source file 2 based on the natural language processing and convert the document content of the source file 2 according to the format of the template file 3 to simply and quickly convert the source file 2 to have a format for every different journal.

According to the exemplary embodiment of the present disclosure, the preprocessor 110, the editor 120, and the converter 130 which have been described above may be implemented by a program which is executed in a computer. Specifically, the editor 120 may be a tool for defining the template file 3 so that a document structure and a document rule be defined by the manipulation of the user. In other words, the editor 120 may include an execution screen through a monitor of the computer and define the template file 3 by editing the document structure and the document rule in the execution screen.

Hereinafter, the execution screen of the editor 120 will be described in detail.

FIG. 2 is an overall execution screen of an editor according to an exemplary embodiment of the present disclosure.

Referring to FIG. 2, the execution screen of the editor 120 may include a new file generation button New (B1), a save button Save (B2), a template button Template (B3), and a converter button Converter (B4). Further, the execution screen of the editor 120 may be configured by a structure tree pane P1, a property pane P2, a property help pane P3, and a result pane.

The new file generation button New (B1) may be a button for generating a new template and be divided into “New Journal button” and “New Journal With Title page button”. The “New Journal button” may be a button for generating the result file 4 in which a title section and a main section are output in a connected page without being separated and “New Journal With Title page button” may be a button for generating a result file 4 in which the title section and the main section are output on separate pages.

Specifically, the title section may be a section which is output on a first page of the result file 4 and include items related to the title, such as title, subtitle, author name, and journal name and the main section may include main content which serve as the main of the result file 4 and items therefor, but is not limited thereto.

The save button Save (B2) may be a button for storing the edited document to generate the template file 3 and include “Save As button” to specify the name of the template file 3. At this time, the stored template file 3 may be stored in the form of “j son” to be loaded in the converter 130 to be located in \executable\docs\template folder, but is not limited thereto.

The template button Template (B3) may be a button for checking whether a template which is being edited is convertible into a word document. In other words, the editor 120 may receive an input for the selection of the template button Template (B3), determine whether the template according to the document structure and the document rule which are being edited can be converted into the word document, and display a response thereto on the execution screen, but is not limited thereto.

The converter button Converter (B4) may be a button for displaying an execution screen of the converter 130. In other words, when the editor 120 receives an input for the selection of the converter button Converter (B4), the converter 130 may be activated by the editor 120, but is not limited thereto.

The structure tree pane P1 may be a window which displays a structure tree representing a structure of a template which is being edited as a tree and display at least one of a file node, a section node N1, a group node N2, and an item node N3 as a tree form, according to the structure of the template.

The file node may refer to a template which is being edited or a template file 3 to be generated, and may be a highest node of the structure tree. The section node N1 may be a node including a title section and a main section and may be a node for dividing a layout. The group node N2 may be a node obtained by grouping a plurality of item nodes N3 and the item node N3 may be a node corresponding to an item which is included in the template file 3, that is, an item which is output to the result file 4. At this time, the item node N3 may be connected to an input item of the source file 2 by a rearrangement property. In other words, the converter 130 may generate the result file 4 by rearranging an input item of the source file 2 in an item corresponding to the item node N3 of the template file 3.

The property pane P2 may be a window for setting a property of the node selected from the structure tree and property elements for editing properties of the nodes may be displayed thereon. Further, every node may include a different property element, but the property element may be added, changed, and deleted.

According to the exemplary embodiment of the present disclosure, the property element may be divided into an upper property element and a lower property element. FIG. 2 illustrates a property pane P2 when the file node is selected from the structure tree. Referring to FIG. 2, the upper property element may include documents, main, rules, and style, but is not limited thereto.

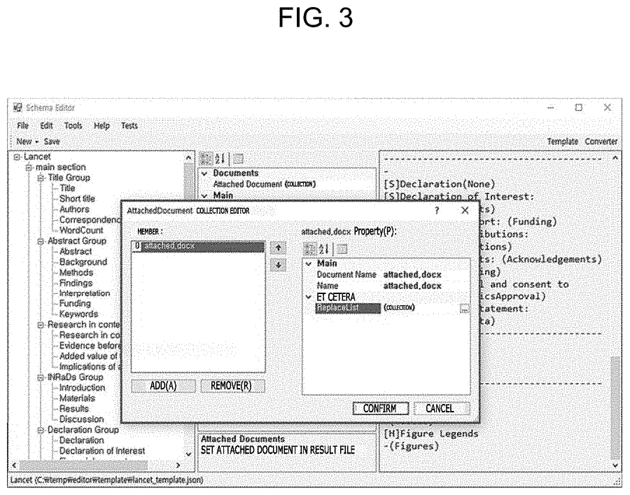

The upper property element and the lower property element are not limited those illustrated in the drawing and described in the present disclosure, but may include various property elements. In the present disclosure, as main lower property elements, “attached document”, “comments”, and “count rules” will be described in more detail below with reference to FIGS. 3 to 5.

The property help pane P3 is a pane for displaying help for the property element selected from the property pane P2 and may display to check explanation of various property elements which have not been mentioned in the present disclosure. FIG. 2 illustrates a property help pane P3 when “attached document” is selected. Referring to FIG. 2, it is confirmed that the property help pane P3 displays “set file attached to result document” as short description for the “attached document”.

The result pane P4 may be a pane for displaying an outline of the template which is being edited. Referring to FIG. 2, it is confirmed that the result pane P4 may display an outline of the template which is being edited, such as declaration, author contribution, and reference. According to the exemplary embodiment of the present disclosure, the outline of the template displayed on the result pane P4 may vary depending on the progress of the editing task, but is not limited thereto.

Hereinafter, as main lower property elements, “attached document”, “comments”, and “count rules” will be described.

FIG. 3 is an execution screen of an editor according to an exemplary embodiment of the present disclosure for generating a separate document. FIG. 3 illustrates an execution screen which is newly displayed when an input for the selection of the “attached document” which is a lower property element of the property pane P2 is received from the user.

Referring to FIG. 3, when there is a need to generate a separate document file other than the result file 4 to be generated, the editor 120 may set a name (file name) and an item of a template file 3 to be replaced, in the separate document file. In other words, when there is a need to generate a separate attached document, rather than one result file 3, according to the format of the journal, the editor 120 replaces content of some items in the source file 2 to generate an attached document including a replaced item and content according to the item.

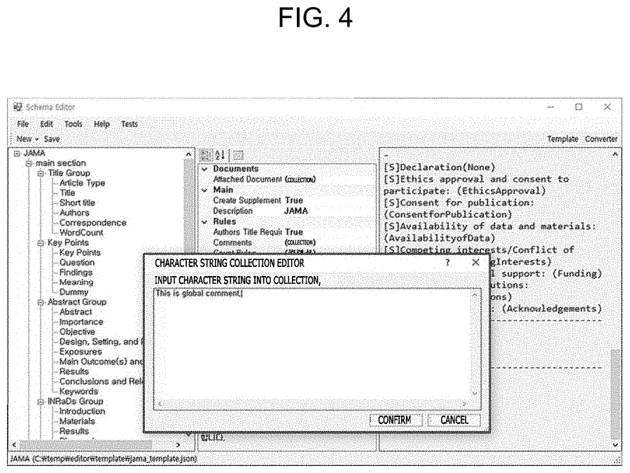

FIG. 4 is an execution screen of an editor according to an exemplary embodiment of the present disclosure for defining a document rule related to comment insertion. FIG. 4 illustrates an execution screen which is newly displayed when an input for the selection of the “comments” which is a lower property element of the property pane P2 is received from the user.

According to the exemplary embodiment of the present disclosure, the editor 120 may set a comment message of a specific item which is output to the result file 4. In other words, the editor 120 may set the comment message for the node selected from the structure tree to be displayed in the result file 4. Specifically, when the editor 120 receives the comment message from the user by means of the execution screen of FIG. 4, the editor 120 may set to display the comment message below the item corresponding to the selected node in the result file 4. The comment may be set for every item in the result file 4 so that the rules for the file node, the section node N1, the group node N2, and the item node N3 may be set for each item, but it is not limited thereto.

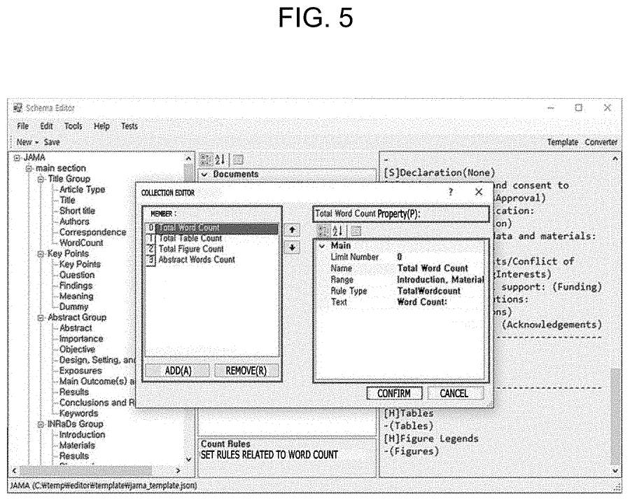

FIG. 5 is an execution screen of an editor according to an exemplary embodiment of the present disclosure for defining a document rule related to limitation of the number. FIG. 5 illustrates an execution screen which is newly displayed when an input for the selection of the “count rules” which is a lower property element of the property pane P2 is received from the user. The “count rules” are rules for the content of the entire file, that is, the content of the entire result file 4 so that the count rules may be set in the property of the file node and when the file node is selected, the count rules may be displayed on the property pane P2, but it is not limited thereto.

According to the exemplary embodiment of the present disclosure, the editor 120 may define the document rule to limit the number of at least one of the characters, tables, and figures of a specific item which is output to the result file 4. In other words, the editor 120 may set to limit the number of characters, words, tables, figures, and references for the node selected from the structure tree to be output to the result file 4.

Specifically, referring to FIG. 5, the execution screen for the “count rules” of the editor 120 may display a member whose number is to be limited at the left side (a 9 o'clock direction of FIG. 5). At this time, the member may include “total word count”, “total table count”, “total figure count”, and “abstract word count”, but is not limited thereto and there may be more detailed and various members.

Further, referring to FIG. 5, the execution screen for the “count rules” of the editor 120 may display a property of a selected member at the right side (a 3 o'clock direction of FIG. 3).

According to the exemplary embodiment of the present disclosure, the editor 120 may receive an input for selecting a member to which count limitation rule is assigned from the user, display the property of the selected member on the execution screen, receive an input for selecting a property of the member from the user, and set the selected property based on the user input. For example, the editor 120 may set “limit number”, “name”, “range”, “rule type”, and “text”, based on the user input. The “limit number” refers to a number of selected members and the “range” may refer to a range of the limited items, but are not limited thereto.

Referring to FIG. 5, for example, the editor 120 may receive an input for the selection of “total word count” from the user, display the property of “total word count” on the execution screen, receive an input corresponding to 3,000 words for the “limit number”, and receive inputs corresponding to “introduction”, “material”, and “methods” for the range to limit the total word count of “introduction”, “material”, and “methods” to 3,000 words, but it is not limited thereto.

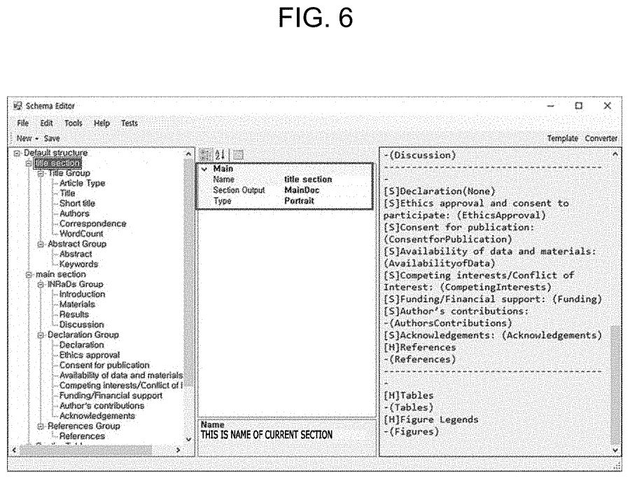

FIG. 6 is an execution screen of an editor according to an exemplary embodiment of the present disclosure for editing a property of a section node.

Referring to FIG. 6, the editor 120 may receive an input for the selection of the section node N1, display the property element for the selected node on the property pane P2, and set each property element based on the user input.

Referring to FIG. 6, for example, when “title section” which is a section node N1 is selected, the editor 120 may display “main” which is an upper property element and “name”, “section output”, and “type” which are lower property elements on the property pane P2. At this time, the “type” may refer to a paper direction of the corresponding section when the result file 4 is generated and include portrait and landscape.

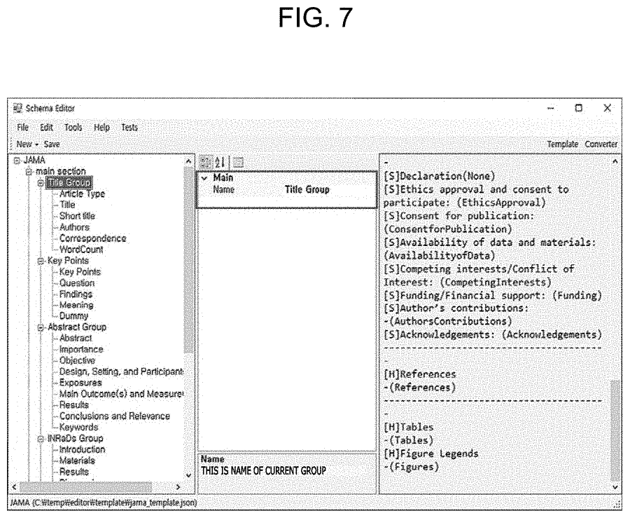

FIG. 7 is an execution screen of an editor according to an exemplary embodiment of the present disclosure for editing a property of a group node. According to the exemplary embodiment of the present disclosure, the group node N2 is a node obtained by grouping the item nodes N3, but is just used as a logical unit so that the property element other than “name” may be not essential. In other words, when the input for the selection of the group node N2 is received, the editor 120 may display only “name” as a property element on the property pane P2, but is not limited thereto.

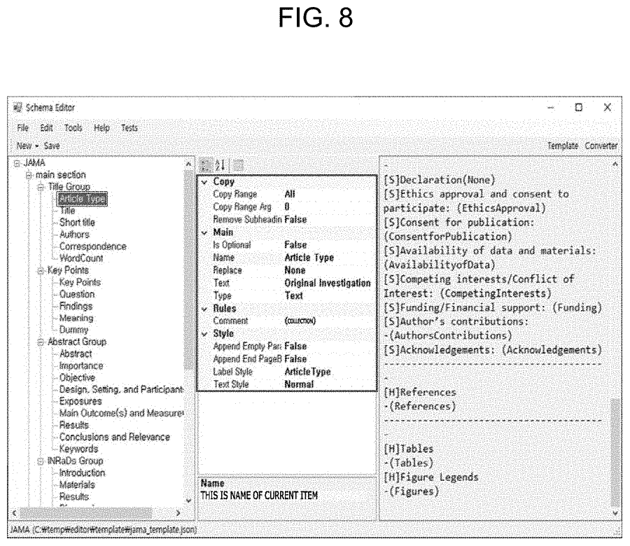

FIG. 8 is an execution screen of an editor according to an exemplary embodiment of the present disclosure for editing a property of an item node.

Referring to FIG. 8, the editor 120 may receive an input for the selection of the item node N3, display the property element for the selected node on the property pane P2, and set each property element based on the user input.

Referring to FIG. 8, for example, when “article type” which is a section node N3 is selected, the editor 120 may display “copy”, “main”, “rules”, and “style” which are upper property elements and lower property elements of each upper property element on the property pane P2.

At this time, “type” which is the lower property element of “main” which is the upper property element may include “text”, “line”, and “paragraph”. When “text” is set as the “type”, the item corresponding to the corresponding item node N3 may not be connected (corresponded) to the input item of the source file 2, but output as a text in the result file 4. Further, when “line” is set as the “type”, the item corresponding to the item node N3 may be output as a text and the input item of the connected (corresponding) source file 2 be output on the same line as the output text. When “paragraph” is set as the “type”, the item corresponding to the item node N3 may be output as a text and the input item of the connected (corresponding) source file 2 be output on a next line of the output text. However, it is not limited thereto.

As described with reference to FIGS. 2 to 8, according to the exemplary embodiment of the present disclosure, the editor 120 may include a structure tree and define a document structure based on the property edition of each node of the structure tree.

As described with reference to FIGS. 2 to 8, the conversion system 100 according to the exemplary embodiment of the present disclosure may define the template file by editing the document structure and the document rules to structurize a different format for every journal.

Further, the execution screen of the editor 120 which has been described with reference to FIGS. 2 to 8 is not limited to the above description and the editor 120 may set and change the properties for the configurations which have been illustrated in the drawings, but have not been described in detail in the present disclosure, according to various exemplary embodiments.

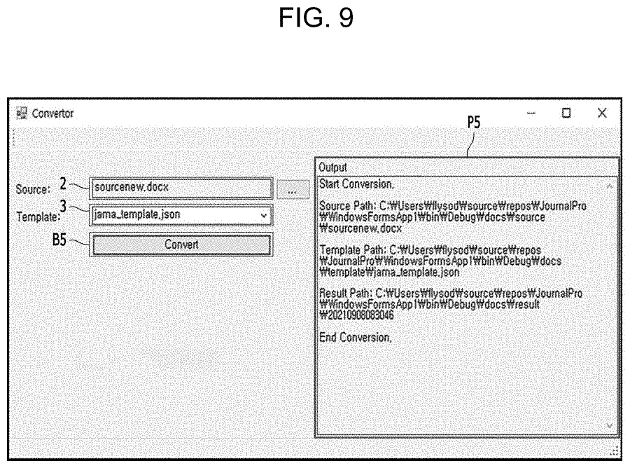

FIG. 9 is an execution screen of a convertor according to an exemplary embodiment of the present disclosure.

According to the exemplary embodiment of the present disclosure, the converter 130 may output the result file 4 with the source file 2 and the template file 3 as inputs. At this time, the result file 4 may be generated as one or a plurality of files according to a format of the journal to be converted.

Referring to FIG. 9, the execution screen of the converter 130 may include a find button to select a source file 2, a combo box to select a template file 3, and a convert button Convert (B5) at the left side. Further, the output textbox P5 may be included at the right side to display a conversion result.

In other words, when the selection for the source file 2 and the template file 3 is received from the user and the input for the convert button is received, the converter 130 may convert the selected file 2 so as to correspond to the document structure and the document rule defined in the selected template file 3 to generate a result file 4 and display the conversion result in the output textbox P5.

The execution screens of the editor 120 and the converter 130 which have been described with reference to FIGS. 2 to 9 are not limited those illustrated in FIGS. 2 to 9.

Hereinafter, an operation flow of the present disclosure will be described in brief based on the above detailed description.

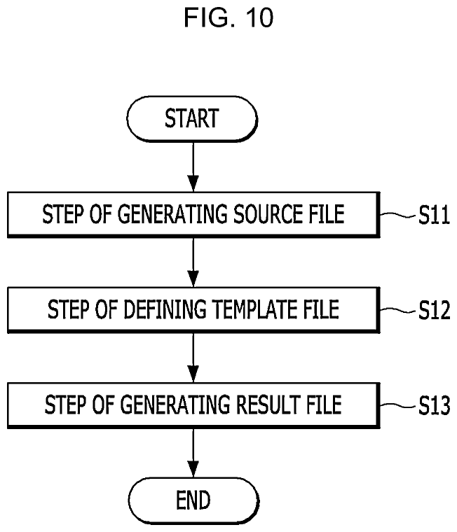

FIG. 10 is a flowchart of an operation of an automatic paper format conversion method according to an exemplary embodiment of the present disclosure.

The automatic paper format conversion method illustrated in FIG. 10 may be performed by the above-described automatic paper format conversion system 100. Accordingly, even though the content which have been described for the automatic paper format conversion system 100 are omitted below, the content of the automatic paper format conversion system 100 may be applied to the description of the automatic paper format conversion method in the same way.

Referring to FIG. 10, in step S11, the preprocessor 110 may generate a source file 2 in which each item is marked by inserting a delimiter into data in the original file 1.

Next, in step S12, the editor 120 may define a template file 3 based on the edition of the document structure and the edition of the document rule. Further, the editor 120 may include a structure tree of the template file 3 and define a document structure based on property edition of each node of the structure tree. At this time, the node may include a section node N1, a group node N2, and an item node N3. The section node N1 may be a node for dividing a layout including a title section and a main section, the group node N2 be a node obtained by grouping a plurality of item nodes N3, and the item node N3 be a node corresponding to an item output to the result file 4. Further, the editor 120 may define the document rule to limit the number of at least one of the words, tables, and figures of a specific item.

Next, in step S13, the converter 130 may receive the source file 2 and the template file 3 as inputs and convert the source file structure so as to correspond to the template file 3 to generate the result file 4. Further, the converter 130 may figure out the source file structure based on natural language processing using a delimiter. Further, the converter 130 may identify an input item based on the source file structure and automatically convert the format of the input item so as to correspond to the document structure and the document rule.

In the above-description, steps S11 and S13 may be further divided into additional steps or combined as smaller steps depending on an implementation example of the present disclosure. Further, some steps may be omitted if necessary and the order of steps may be changed.

The automatic paper format conversion method according to the exemplary embodiment of the present disclosure may be implemented as a program command form which may be executed by various computers to be recorded in a computer readable medium. The computer readable medium may include solely a program command, a data file, and a data structure or a combination thereof. The program instruction recorded in the medium may be specifically designed or constructed for the present disclosure or known to those skilled in the art of a computer software to be used. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, specially formed to store and execute a program command. Examples of the program command include not only a machine language code which is created by a compiler but also a high level language code which may be executed by a computer using an interpreter. The hardware device may operate as one or more software modules in order to perform the operation of the present disclosure and vice versa.

Further, the above-described automatic paper format conversion method may also be implemented as a computer program or an application executed by a computer which is stored in a recording medium.

The above-description of the present disclosure is illustrative only and it is understood by those skilled in the art that the present disclosure may be easily modified to another specific type without changing the technical spirit of an essential feature of the present disclosure. Thus, it is to be appreciated that the embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. An automatic paper format conversion system, comprising:
an editor which defines a template file based on edition of a document structure and edition of a document rule; and
a converter which receives a source file and the template file as inputs and converts a source file structure so as to correspond to the template file to generate a result file.

2. The automatic paper format conversion system according to claim 1, further comprising:
a preprocessor which generates a source file in which each item is marked by inserting a delimiter into data in an original file;
wherein the converter figures out the source file structure based on natural language processing using the delimiter.

3. The automatic paper format conversion system according to claim 2, wherein the converter identifies an input item based on the source file structure and automatically converts a format of the input item so as to correspond to the document structure and the document rule.

4. The automatic paper format conversion system according to claim 1, wherein the editor incudes a structure tree and defines the document structure based on edition of the property of each node of the structure tree.

5. The automatic paper format conversion system according to claim 4, wherein the node includes a section node, a group node, and an item node, the section node is a node for dividing a layout including a title section and a main section, the group node is a node obtained by grouping a plurality of the item nodes, and the item node is a node corresponding to an item output to the result file.

6. The automatic paper format conversion system according to claim 1, wherein the editor defines the document rule to limit the number of at least one of characters, tables, and figures of a specific item.

7. An automatic paper format conversion method, comprising:
defining a template file based on edition of a document structure and edition of a document rule; and
generating a result file by receiving a source file and the template file as inputs and converting a source file structure so as to correspond to the template file.

8. The automatic paper format conversion method according to claim 7, further comprising:
generating a source file in which each item is marked by inserting a delimiter into data in an original file;
wherein in the generating of a result file, the source file structure is figured out based on natural language processing using the delimiter.

9. The automatic paper format conversion method according to claim 8, wherein in the generating of a result file, an input item is identified based on the source file structure and a format of the input item is automatically converted so as to correspond to the document structure and the document rule.

10. The automatic paper format conversion method according to claim 7, wherein in the defining of the template file, the document structure is defined based on the edition of the property of each node of the structure tree.

11. The automatic paper format conversion method according to claim 10, wherein the node includes a section node, a group node, and an item node, the section node is a node for dividing a layout including a title section and a main section, the group node is a node obtained by grouping a plurality of the item nodes, and the item node is a node corresponding to an item output to the result file.

12. The automatic paper format conversion method according to claim 7, wherein in the defining of the template file, the document rule is defined to limit the number of at least one of characters, tables, and figures of a specific item.

13. A non-transitory computer readable recording medium in which a program allowing a computer to execute the method of claim 7 is recorded.

14. A non-transitory computer readable recording medium in which a program allowing a computer to execute the method of claim 8 is recorded.

15. A non-transitory computer readable recording medium in which a program allowing a computer to execute the method of claim 9 is recorded.

16. A non-transitory computer readable recording medium in which a program allowing a computer to execute the method of claim 10 is recorded.

17. A non-transitory computer readable recording medium in which a program allowing a computer to execute the method of claim 11 is recorded.

18. A non-transitory computer readable recording medium in which a program allowing a computer to execute the method of claim 12 is recorded.
